(19) United States
(12) Patent Application Publication
(10) Pub. No.: US 2026/0124947 A1
(43) Pub. Date: May 7, 2026

(54) CONTROL DEVICE AND OPERATING METHOD FOR AUTHENTICATION

(71) Applicant: Wistron Corporation, New Taipei City (TW)

(72) Inventor: Yu Ju Lee, New Taipei City (TW)

(73) Assignee: Wistron Corporation, New Taipei City (TW)

(21) Appl. No.: 19/002,648

(22) Filed: Dec. 26, 2024

(30) Foreign Application Priority Data
Nov. 7, 2024 (TW) 113142676

(51) Int. Cl. B60L 53/65; H02J 7/00

(52) U.S. Cl. CPC B60L 53/65; H02J 7/47

(57) ABSTRACT

A control device and an operating method for authentication are provided. The control device includes a connection terminal, a transmission terminal, a first switch, a second switch, a controller, and a signal processing circuit. The first switch is coupled between the connection terminal and the transmission terminal. A first end of the second switch is coupled to the connection terminal. The controller is coupled to a second end of the second switch. The controller turns on the second switch and turns off the first switch in response to a proximity pilot signal being within a setting parameter range to enter a first state. The signal processing circuit receives a virtual proximity pilot signal within the setting parameter range in the first state, converts the virtual proximity pilot signal into communication data, and provides the communication data to the controller.

### CROSS-REFERENCE TO RELATED APPLICATION

This application claims the priority benefit of Taiwan Patent Application serial No. 113142676, filed on Nov. 7, 2024. The entirety of the above-mentioned patent application is hereby incorporated by reference herein and made a part of this specification.

### BACKGROUND

### Technical Field

The disclosure relates to a control device and an operating method, and in particular, to a control device and an operating method for authentication.

### Description of Related Art

At present, electric vehicles (e.g., any form of electric cars) can be charged using charging stations. However, when it comes to the authentication process, a user may need to complete a series of steps, including plugging the charging gun of the charging station into the electric vehicle, finding the corresponding application through a terminal device, registering or logging into the application, and inputting identification information of the charging station or charging gun, etc. Only after these authentication processes can the charging station begin to charge the electric vehicle. It is evident that this series of complicated authentication processes brings inconvenience to users. Therefore, simplifying the aforementioned authentication process becomes crucial.

### SUMMARY

The disclosure provides a control device and an operation method through which the authentication process before charging an electric vehicle is simplified.

In an embodiment of the disclosure, a control device includes a connection terminal, a transmission terminal, a first switch, a second switch, a controller, and a signal processing circuit. The connection terminal transmits a proximity pilot signal. The transmission terminal transmits a virtual proximity pilot signal. The virtual proximity pilot signal is within a setting parameter range. A first end of the first switch is coupled to the connection terminal. A second end of the first switch is coupled to the transmission terminal. A first end of the second switch is coupled to the connection terminal. The controller is coupled to a control end of the first switch, a second end of the second switch, and a control end of the second switch. In response to the proximity pilot signal being within the setting parameter range, the controller turns on the second switch and turns off the first switch to enter a first state. The signal processing circuit is coupled to the controller and the transmission terminal. The signal processing circuit receives a first virtual proximity pilot signal within the setting parameter range in the first state, converts the first virtual proximity pilot signal into first communication data for participating in a first authentication process, and provides the first communication data to the controller.

In an embodiment of the disclosure, an operating method includes the following steps. A control device is provided. The control device enters a first state in response to a proximity pilot signal being within a setting parameter range. The control device receives a first virtual proximity pilot signal within the setting parameter range in the first state and converts the first virtual proximity pilot signal into first communication data for participating in a first authentication process.

In an embodiment of the disclosure, a control device includes a connection terminal, a transmission terminal, a first switch, a second switch, a controller, and a signal processing circuit. The connection terminal transmits a proximity pilot signal. The transmission terminal transmits a virtual proximity pilot signal. The virtual proximity pilot signal is within a setting parameter range. A first end of the first switch is coupled to the connection terminal. A second end of the first switch is coupled to the transmission terminal. A first end of the second switch is coupled to the connection terminal. The controller is coupled to a control end of the first switch, a second end of the second switch, and a control end of the second switch. In response to the proximity pilot signal being within the setting parameter range, the controller turns on the second switch and turns off the first switch to enter a first state. The signal processing circuit is coupled to the controller and the transmission terminal. The signal processing circuit receives virtual proximity pilot signal within the setting parameter range in the first state, converts the virtual proximity pilot signal into communication data for participating in an authentication process, and provides the communication data to the controller.

To sum up, in response to the proximity pilot signal being within the setting parameter range, the control device enters the first state to convert the first virtual proximity pilot signal into the first communication data. Therefore, the control device may utilize the first communication data to participate in the authentication process. In this way, a method to simplify the authentication process is provided in the disclosure.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a control device according to an embodiment of the disclosure.

FIG. 2 is a flow chart illustrating an operating method according to an embodiment of the disclosure.

FIG. 3 is a schematic diagram illustrating control devices according to an embodiment of the disclosure.

FIG. 4 is a flow chart illustrating communication of the control device according to an embodiment of the disclosure.

FIG. 5A and FIG. 5B are flow charts illustrating operations of the control device according to an embodiment of the disclosure.

FIG. 6A to FIG. 6C are flow charts illustrating the operations of the control device according to an embodiment of the disclosure.

FIG. 7 is a schematic diagram illustrating an operation of a signal processing circuit according to an embodiment of the disclosure.

FIG. 8A to FIG. 8C are schematic diagrams illustrating control devices according to an embodiment of the disclosure.

### DESCRIPTION OF THE EMBODIMENTS

Several embodiments of the disclosure are described in detail below accompanying with figures. In terms of the reference numerals used in the following descriptions, the same reference numerals in different figures should be considered as the same or the like elements. The embodiments are only a portion of the disclosure, which do not present all embodiments of the disclosure. More specifically, these embodiments are only examples in the scope of the patent application of the disclosure.

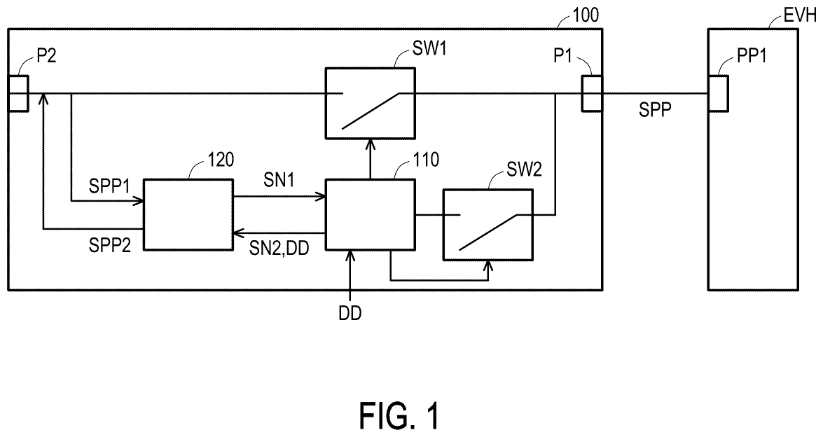

With reference to FIG. 1, FIG. 1 is a schematic diagram illustrating a control device according to an embodiment of the disclosure. In an embodiment, a control device 100 includes a connection terminal P1, a transmission terminal P2, switches SW1 and SW2, a controller 110, and a signal processing circuit 120. The connection terminal P1 is configured to transmit a proximity pilot signal SPP. The transmission terminal P2 is configured to transmit the proximity pilot signal SPP and a virtual proximity pilot signal. A first end of switch SW1 is coupled to the connection terminal P1. A second end of switch SW1 is coupled to the transmission terminal P2. A first end of switch SW2 is coupled to the connection terminal P1.

In an embodiment, the controller 110 is coupled to a control end of switch SW1, a second end of switch SW2, and a control end of switch SW2. In response to receiving the proximity pilot signal SPP being within a setting parameter range, the controller 110 turns on the switch SW2 and turns off the switch SW1, so that the control device 100 enters a first state.

In an embodiment, the signal processing circuit 120 is coupled to the controller 110 and the transmission terminal P2. For instance, the signal processing circuit 120 may be coupled to the controller 110 via the UART protocol, but the disclosure is not limited thereto. In the first state, the signal processing circuit 120 receives a first virtual proximity pilot signal SPP1 within the setting parameter range via the transmission terminal P2, converts the first virtual proximity pilot signal SPP1 into first communication data SN1 for participating in a control device authentication process (also called a first authentication process), and provides the first communication data SN1 to the controller 110. Therefore, the controller 110 receives the first communication data SN1 and participates in the control device authentication process based on the first communication data SN1.

It is worth mentioning herein that in response to the proximity pilot signal SPP being within the setting parameter range, the control device 100 enters the first state to convert the first virtual proximity pilot signal SPP1 into the first communication data SN1. Therefore, the control device 100 may automatically participate in and execute the control device authentication process using the first communication data SN1.

For instance, the control device 100 may be used in an electric vehicle EVH (the disclosure is not limited to the application of the control device 100 in the electric vehicle EVH). The control device 100 is arranged on the electric vehicle EVH. The electric vehicle EVH may be any form of electric vehicle. The connection terminal P1 is coupled to a proximity pilot terminal PP1 of the electric vehicle EVH. The controller 110 may obtain a voltage value of the proximity pilot signal SPP through at least one of the connection terminal P1 and the transmission terminal P2. Taking the J1772 specification as an example, the setting parameter range may be a setting voltage value range, but the disclosure is not limited thereto. In an embodiment, the setting parameter range may be a setting current range, a setting frequency range, or a setting phase range. When the electric vehicle EVH is connected to a charging station, the voltage value of the proximity pilot signal SPP is between 1.3 volts and 1.7 volts (i.e., 1.5±0.2V), but the disclosure is not limited to this embodiment. When the electric vehicle EVH is not connected to a charging station, the voltage value of the proximity pilot signal SPP is approximately 4.5 volts. Therefore, when the voltage value of the proximity pilot signal SPP is within the setting voltage value range (i.e., 1.5±0.2V), the controller 110 determines that the electric vehicle EVH is connected to a charging station through the control device 100. The controller 110 then turns on the switch SW2 and turns off the switch SW1 to enter the first state. On the other hand, when the voltage value of the proximity pilot signal SPP is outside the setting voltage value range, the controller 110 determines that the electric vehicle EVH is not connected to a charging station. The controller 110, in response to the proximity pilot signal SPP outside the setting voltage value range, then determines that the electric vehicle EVH is not connected to a charging station (not shown) and thus turns off the switch SW2 and turns on the switch SW1 to enter a second state. The second state may be an initial state where the electric vehicle EVH is not connected to a charging station.

In the first state, the control device 100 provides a way to simplify an authentication process for a user before charging the electric vehicle EVH. Further, in the first state, the control device 100 further provides the first virtual proximity pilot signal SPP1 to the proximity pilot terminal PP1 of the electric vehicle EVH via the switch SW2. The voltage value of the first virtual proximity pilot signal SPP1 is within the setting voltage value range (i.e., 1.5±0.2V). In this way, in the first state, the first virtual proximity pilot signal SPP1 replaces the proximity pilot signal SPP. In the first state, the electric vehicle EVH and the charging station may recognize that they are currently in a proximity state based on the first virtual proximity pilot signal SPP1.

In an embodiment, the controller 110 provides second communication data SN2 for participating in the device authentication process. The signal processing circuit 120 converts the second communication data SN2 into a second virtual proximity pilot signal SPP2 within the setting parameter range and provides the second virtual proximity pilot signal SPP2 to the transmission terminal P2. In an embodiment, in the first state, the controller provides the second communication data SN2 based on the first communication data SN1 after receiving the first communication data SN1.

In addition, in the first state, the controller 110 receives an identification code DD from the electric vehicle EVH and provides the identification code DD to the charging station to perform an authentication process (also known as a second authentication process) for the electric vehicle EVH. In response to passing the authentication process of the electric vehicle EVH, the controller 110 turns on the switch SW1 and turns off the switch SW2 to enter the second state and proceeds with a charging process.

In an embodiment, each of the switches SW1 and SW2 may be implemented by at least one transistor switch, relay, or transmission gate. In an embodiment, the controller 110 may be, for example, a central processing unit (CPU), a programmable microprocessor for general or special use, a digital signal processor (DSP), a programmable controller, an application specific integrated circuit (ASIC), a programmable logic device (PLD), or any other similar devices or a combination of the foregoing devices, and may be loaded to run a computer program.

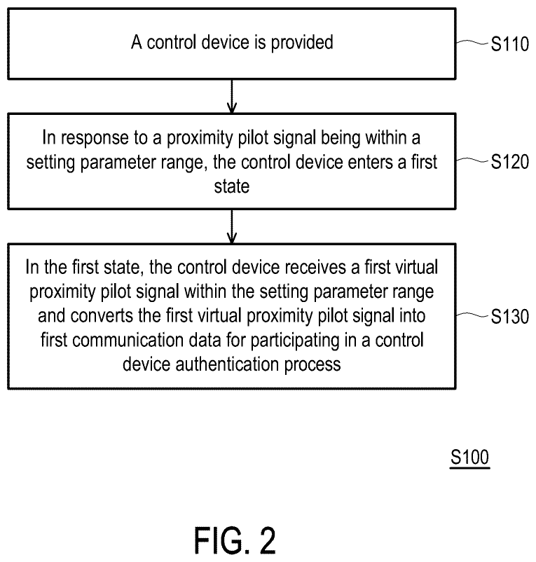

With reference to FIG. 1 and FIG. 2, FIG. 2 is a flow chart illustrating an operating method according to an embodiment of the disclosure. In an embodiment, an operating method S100 includes steps S110 to S130. In step S110, the control device 100 is provided. In step S120, in response to the proximity pilot signal SPP being within the setting parameter range, the control device 100 enters the first state. In step S130, in the first state, the control device 100 receives the first virtual proximity pilot signal SPP1 within the setting parameter range and converts the first virtual proximity pilot signal SPP1 into the first communication data SN1 for participating in the device authentication process. The controller 110 may participate in the control device authentication process based on the first communication data SN1.

The implementation details of steps S120 and S130 are clearly explained in the embodiment of FIG. 1, so description thereof is not repeated herein.

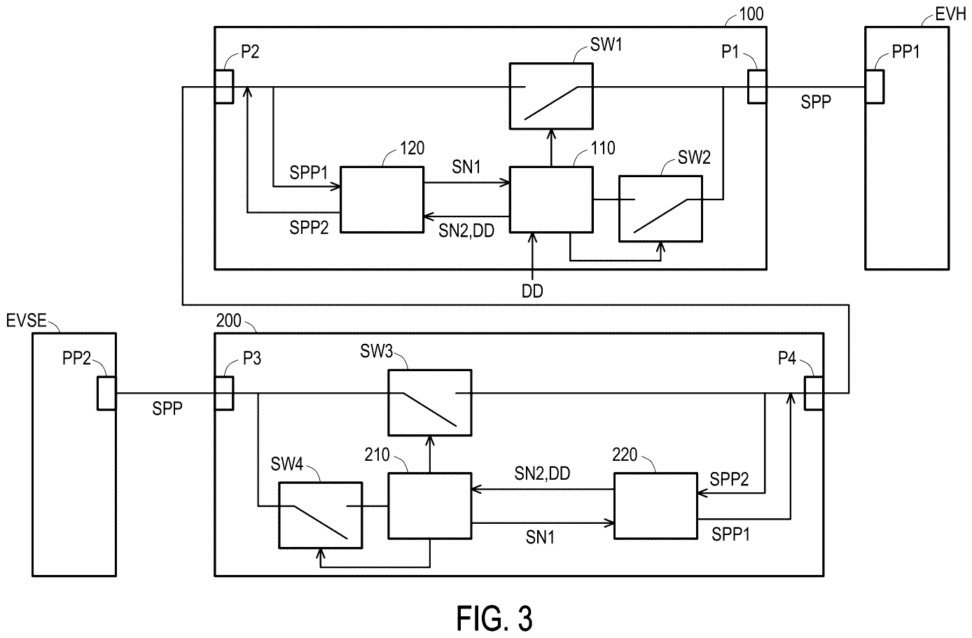

With reference to FIG. 3, FIG. 3 is a schematic diagram illustrating control devices according to an embodiment of the disclosure. The control device 100 includes the connection terminal P1, the transmission terminal P2, the switches SW1 and SW2, the controller 110, and the signal processing circuit 120. The coupling of the connection terminal P1, the transmission terminal P2, the switches SW1 and SW2, the controller 110, and the signal processing circuit 120 is clearly explained in the embodiments of FIG. 1, so description thereof is not repeated herein.

To be specific, a control device 200 includes a connection terminal P3, a transmission terminal P4, switches SW3 and SW4, a controller 210, and a signal processing circuit 220. The connection terminal P3 transmits the proximity pilot signal SPP. A first end of switch SW3 is coupled to the connection terminal P3. A second end of switch SW3 is coupled to the transmission terminal P4. A first end of switch SW4 is coupled to the connection terminal P3. When the electric vehicle EVH is connected to a charging station EVSE, the transmission terminal P4 is electrically connected to the transmission terminal P2. In an embodiment, the controller 210 is coupled to a control end of the switch SW3, a second end of switch SW4, and a control end of switch SW4. In response to the proximity pilot signal SPP being within the setting parameter range, the controller 210 turns on the switch SW4 and turns off the switch SW3 to enter the first state. The signal processing circuit 220 is coupled to the controller 210 and the transmission terminal P4. In the first state, the controller 210 provides the first communication data SN1. The signal processing circuit 220 receives the first communication data SN1, converts the first communication data SN1 into the first virtual proximity pilot signal SPP1 within the setting parameter range, and provides the first virtual proximity pilot signal SPP1 to the transmission terminal P4. The signal processing circuit 120 receives the first virtual proximity pilot signal SPP1 via the transmission terminal P2, converts the first virtual proximity pilot signal SPP1 back to the first communication data SN1 for participating in the control device authentication process, and provides the first communication data SN1 to the controller 110.

In an embodiment, after the control device 100 receives the first communication data SN1, the controller 110 provides the second communication data SN2. The signal processing circuit 120 converts the second communication data SN2 into the second virtual proximity pilot signal SPP2 within the setting parameter range and provides the second virtual proximity pilot signal SPP2 to the transmission terminal P2. The signal processing circuit 220 receives the second virtual proximity pilot signal SPP2 via the transmission terminal P4, converts the second virtual proximity pilot signal SPP2 back to the second communication data SN2 for participating in the control device authentication process, and provides the second communication data SN2 to the controller 210. Therefore, the controller 210 may identify the control device 100 based on the second communication data SN2.

For instance, the control device 100 is arranged on the electric vehicle EVH. The control device 200 is arranged on the charging station EVSE. The control device 200 is connected to a proximity pilot terminal PP2 of the charging station EVSE. The connection terminal P3 is coupled to the proximity pilot terminal PP2 of the charging station EVSE. In response to the proximity pilot signal SPP being within the setting parameter range, the control device 200 determines that the electric vehicle EVH is connected to the charging station EVSE and enters the first state.

For instance, in response to the proximity pilot signal SPP being within the setting parameter range, the controller 210 determines that the electric vehicle EVH is connected to the charging station EVSE and thus turns on the switch SW4 and turns off the switch SW3 to enter the first state. For instance, the setting parameter range may be a setting voltage value range, but the disclosure is not limited thereto. In an embodiment, the setting parameter range may be a setting current range, a setting frequency range, or a setting phase range. The controller 210 may obtain the voltage value of the proximity pilot signal SPP through at least one of the connection terminal P3 and the transmission terminal P4. Taking the J1772 specification as an example again, when the voltage value of the proximity pilot signal SPP is within the setting voltage value range (i.e., 1.5±0.2V), the controller 210 determines that the charging station EVSE is connected to the electric vehicle EVH through the control device 200 and the control device 100. Therefore, the controller 210 turns on the switch SW4 and turns off the switch SW3 to enter the first state. On the other hand, when the voltage value of the proximity pilot signal SPP is outside the setting voltage value range, the controller 210 determines that the charging station EVSE is not connected to the electric vehicle EVH. Therefore, the controller 210, in response to the proximity pilot signal SPP being outside the setting voltage value range, determines that the charging station EVSE is not connected to the electric vehicle EVH and thus turns off the switch SW4 and turns on the switch SW3 to enter the second state. In the first state, the controller 210 provides the first communication data SN1 for participating in the control device authentication process.

In addition, in the first state, the control device 100, for example, receives the identification code DD from the electric vehicle EVH and provides the identification code DD to the control device 200 to perform the authentication process of the electric vehicle EVH. In response to passing the authentication process of the electric vehicle EVH, the control device 100 and the control device 200 are controlled to enter the second state.

In an embodiment, in the first state, the controller 110 may, for example, receive the identification code DD through any type of vehicle bus (such as CAN bus, but the disclosure is not limited to this embodiment). In another embodiment, the controller 110 may receive the identification code DD through a wired transmission method or a wireless transmission method.

As another example, the controller 110 may receive the identification code DD through any type of vehicle bus. The signal processing circuit 120 converts the identification code DD into a third virtual proximity pilot signal (not shown) within the setting parameter range. The signal processing circuit 220 receives the third virtual proximity pilot signal via the transmission terminal P4, converts the third virtual proximity pilot signal back to the identification code DD, and provides the identification code DD to the controller 210. The controller 210 may identify the electric vehicle EVH based on the identification code DD. Besides, in the first state, the controller 210 provides the third virtual proximity pilot signal to the proximity pilot terminal PP2 of the charging station EVSE via the switch SW4.

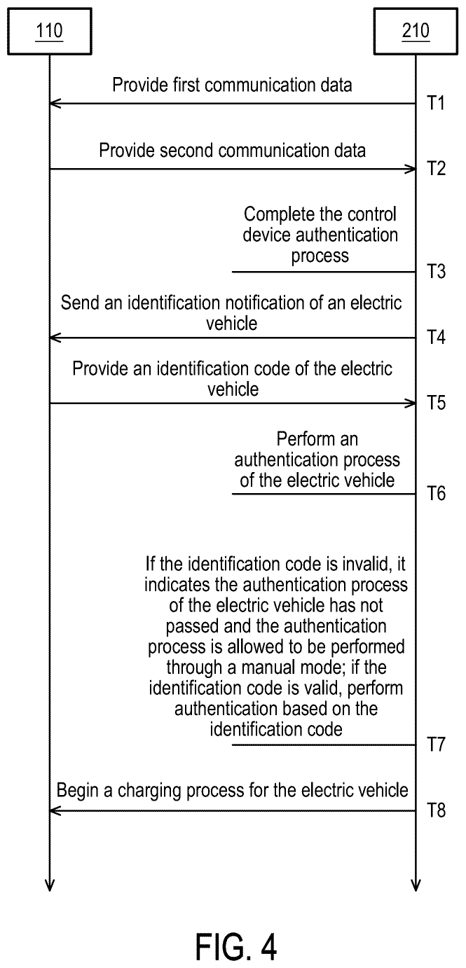

With reference to FIG. 3 and FIG. 4, FIG. 4 is a flow chart illustrating communication of the control device according to an embodiment of the disclosure. FIG. 4 shows a communication process of the controllers 110 and 210 in the first state. For instance, the control device 100 and the control device 200 may utilize half-duplex communication for transmission, such as using the walkie-talkie communication method, which allows bidirectional data transmission between two devices, but not simultaneously. Therefore, only one device is allowed to transmit data at a time. If another device needs to transmit data, it has to wait until the original data-transmitting device has completed its transmission. This sequential communication ensures the completion of identity authentication or identification of the electric vehicle EVH.

At a time point T1, the controller 210 provides the first communication data SN1. After receiving the first communication data SN1, the controller 110 provides the second communication data SN2 at a time point T2. The controller 210 receives the second communication data SN2 at the time point T2. For instance, at the time point T1, the controller 210 provides the first communication data SN1 which may include a message “vehicle, this is evse, **Come In, Over**” and waits for the second communication data SN2. If the controller 210 does not receive the second communication data SN2, the controller 210 provides the same first communication data SN1 again. At the time point T2, the controller 110 provides the second communication data SN2 which may include a message “evse, this is vehicle, **Go ahead, Over**”. The controller 210 receives the second communication data SN2 and is able to identify the message of the second communication data SN2. Therefore, the controller 210 completes the control device authentication process at a time point T3.

The implementation details of sending and converting the first communication data SN1 and the second communication data SN2 in this embodiment are clearly explained in the embodiment of FIG. 3, so description thereof is not repeated herein.

At a time point T4, the controller 210 sends an identification notification of the electric vehicle EVH to the control device 100 to request the control device 100 to provide the identification code DD of the electric vehicle EVH. At a time point T5, the controller 110, in response to the identification notification, receives the identification code DD from the electric vehicle EVH and provides the identification code DD to the controller 210. The implementation details of sending the identification code DD in this embodiment are clearly explained in the embodiment of FIG. 3, so description thereof is not repeated herein.

At a time point T6, the controller 210 performs the authentication process of the electric vehicle EVH based on the identification code DD. For instance, the controller 210 may send the identification code DD to a server (not shown), and the server may make a determination on the identification code DD (the disclosure is not limited thereto). The server may provide a determination result to the controller 210.

At a time point T7, if the determination result indicates that the identification code DD is an invalid identification code, it is considered that the authentication process of the electric vehicle EVH has not passed. The controller 210 may not initiate the charging process for the electric vehicle EVH. For instance, when the electric vehicle EVH is not registered and entitled to use, the determination result indicates that the identification code DD is an invalid identification code. When the electric vehicle EVH is registered and entitled, the determination result indicates that the identification code DD is a valid identification code. In an embodiment, in the situation where the authentication process of the electric vehicle EVH has not passed, the user may, for example, execute the authentication process through a manual mode. For instance, when the authentication process of the electric vehicle EVH has not passed, the control device 100 and the control device 200 are controlled to enter the second state, that is, the controller 110 turns on the switch SW1 and turns off the switch SW2, and the controller 210 turns on the switch SW3 and turns off the switch SW4. Next, the user may perform the authentication process through the manual mode. For instance, the user needs to provide relevant information through a mobile phone application or an operation interface of the charging station EVSE, such as: credit card information, license plate information, selection of charging plan, etc. The charging process may only be carried out when the user completes the authentication process. Therefore, based on the manual mode, the charging station EVSE may still charge the electric vehicle EVH.

Moreover, at the time point T7, if the determination result indicates that the identification code DD is a valid identification code, the controller 210 performs authentication based on the identification code DD, that is, entitling the electric vehicle EVH. Once the entitling and authenticating is completed, the identification code DD is confirmed as a valid identification code. Therefore, at a time point T8, the controller 210 controls the charging station EVSE to start the charging process for the electric vehicle EVH.

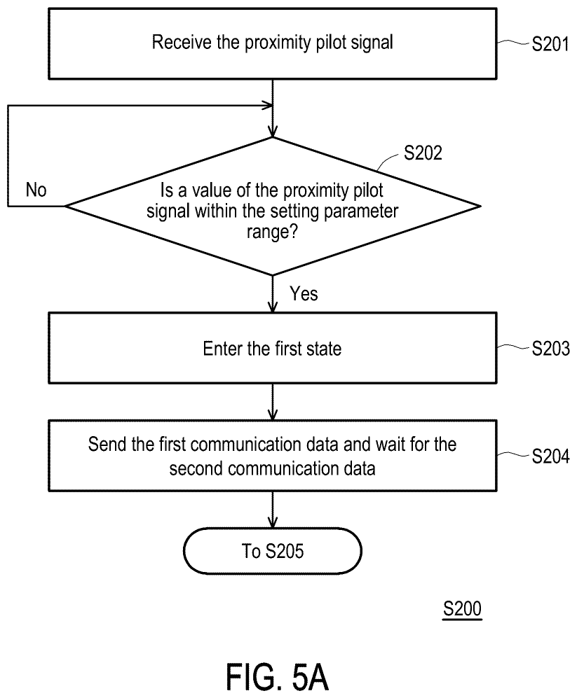

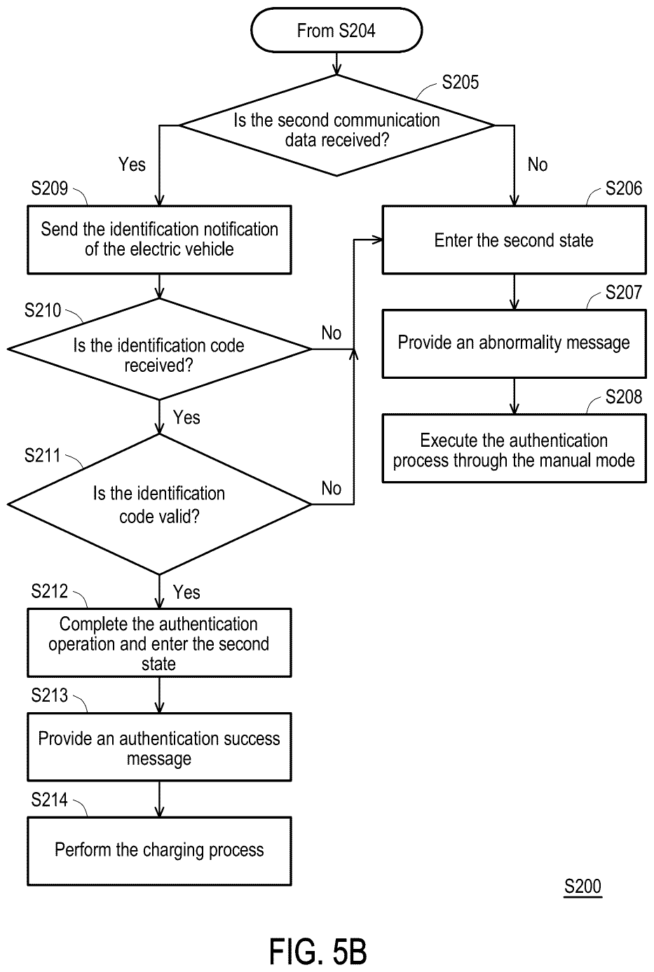

With reference to FIG. 3, FIG. 5A, and FIG. 5B, FIG. 5A and FIG. 5B are flow charts illustrating operations of the control device according to an embodiment of the disclosure. In one embodiment, an operating process S200 of the control device 200 includes steps S201 to S214. In step S201, the controller 210 receives the proximity pilot signal SPP from the proximity pilot terminal PP2 of the charging station EVSE. In step S202, the controller 210 determines whether the voltage value of the proximity pilot signal SPP is within the setting parameter range. When the voltage value of the proximity pilot signal SPP is outside the setting parameter range, the controller 210 will return to the operation of step S202. When the voltage value of the proximity pilot signal SPP is within the setting parameter range, the controller 210 determines that the charging station EVSE is connected to the electric vehicle EVH. Therefore, in step S203, the controller 210 controls the control device 200 to enter the first state, and in step S204, sends the first communication data SN1 and waits for the second communication data SN2 from the control device 100.

In step S205, if the second communication data SN2 is not received within a duration, the controller 210 controls the control device 200 to enter the second state in step S206 to bypass the proximity pilot signal SPP. Next, in step S207, the controller 210 provides an abnormality message regarding not receiving the second communication data SN2, and in step S208, executes the authentication process through the manual mode. The manual mode is clearly explained in the embodiment of the time point T7 in FIG. 4, so description thereof is not repeated herein.

In step S205, if the second communication data SN2 is received, this indicates the completion of the control device authentication process. Therefore, in step S209, the controller 210 sends the identification notification of the electric vehicle EVH to the control device 100 to request the control device 100 to provide the identification code DD of the electric vehicle EVH.

In step S210, if the identification code DD of the electric vehicle EVH is not received within a duration, the controller 210 executes the operation of step S206. If the identification code DD of the electric vehicle EVH is received, the controller 210 determines whether the identification code DD is a valid identification code in step S211. If the identification code DD is an unidentifiable invalid identification code, the controller 210 executes the operation of step S206. If the identification code DD is a valid identification code, the controller 210 completes the authentication process of the electric vehicle EVH in step S212 and controls the control device 200 to enter the second state to bypass the proximity pilot signal SPP.

Next, the controller 210 provides an authentication success message in step S213 and proceeds with the charging process in step S214.

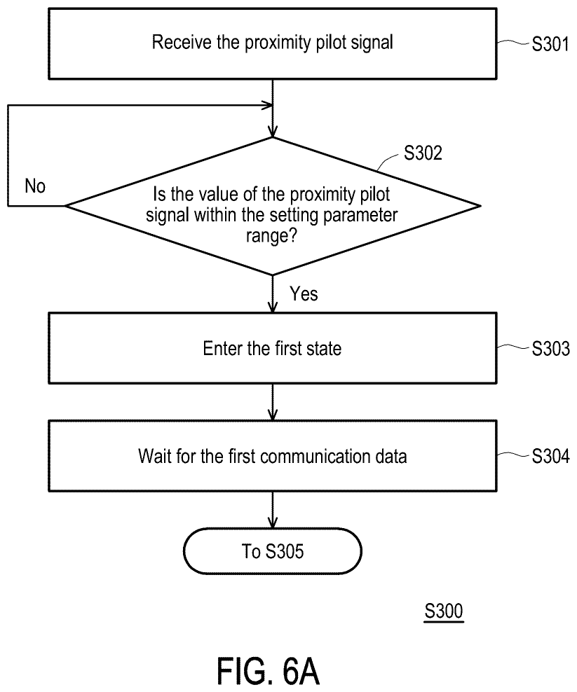

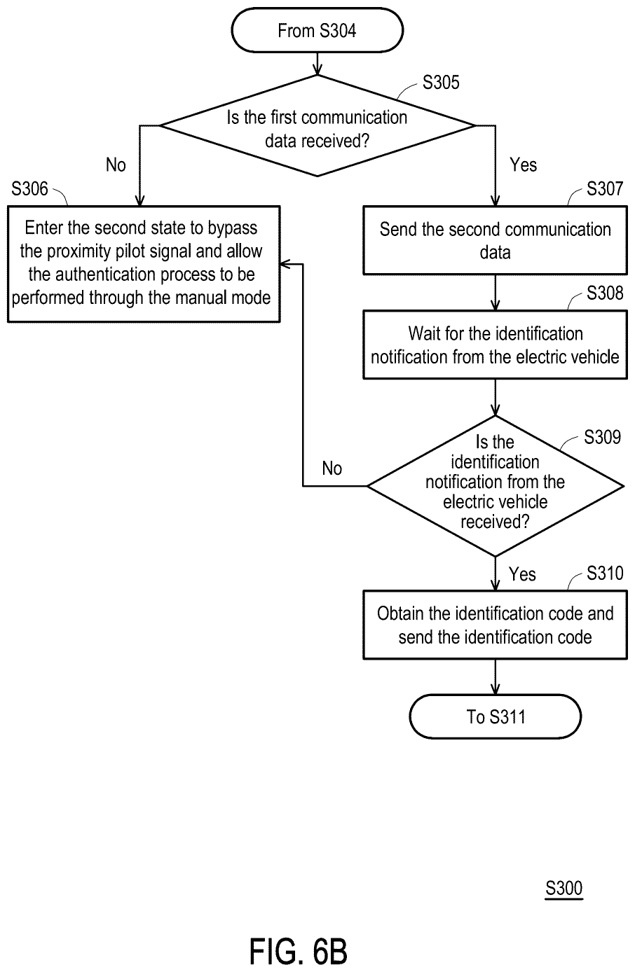

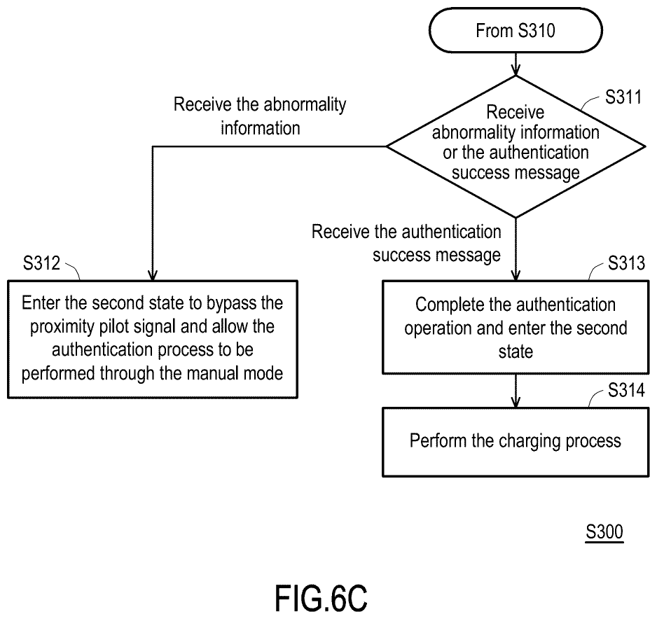

With reference to FIG. 3, FIG. 6A, FIG. 6B and FIG. 6C., FIG. 6A, FIG. 6B, and FIG. 6C are flow charts illustrating the operations of the control device according to an embodiment of the disclosure. In an embodiment, the operating process S300 of the control device 100 includes steps S301 to S314. In step S301, the controller 110 receives the proximity pilot signal SPP from the proximity pilot terminal PP1 of the electric vehicle EVH. In step S302, the controller 110 determines whether the voltage value of the proximity pilot signal SPP is within the setting parameter range. When the voltage value of the proximity pilot signal SPP is outside the setting parameter range, the controller 110 returns to the operation of step S302. When the voltage value of the proximity pilot signal SPP is within the setting parameter range, the controller 110 determines that the charging station EVSE is connected to the electric vehicle EVH. Therefore, the controller 110 controls the control device 100 to enter the first state in step S303 and waits for the first communication data SN1 from the control device 200 in step S304.

In step S305, if the first communication data SN1 is not received within a duration, the controller 110 controls the control device 100 to enter the second state in step S306 to bypass the proximity pilot signal SPP and allows the authentication process to be performed through manual mode. Therefore, when the user completes the authentication process through the manual mode, the charging station EVSE may still charge the electric vehicle EVH. The manual mode is clearly explained in the embodiment of the time point T7 in FIG. 4, so description thereof is not repeated herein. On the other hand, if the first communication data SN1 is received, the controller 110 sends the second communication data SN2 to the control device 200 in step S307 and waits for the identification notification of the electric vehicle EVH from the control device 200 in step S308.

In step S309, if the identification notification of the electric vehicle EVH from the control device 200 is not received within a duration, the controller 110 performs the operation of step S306. On the other hand, if the identification notification of the electric vehicle EVH from the control device 200 is received, the controller 110 obtains the identification code DD from the electric vehicle EVH in step S310 and sends the identification code DD to the control device 200.

In step S311, if an abnormality message is received from the control device 200, this indicates that the identification code DD from the electric vehicle EVH is an invalid identification code. The identification code DD of the electric vehicle EVH is not entitled. Therefore, the controller 110 and the controller 210 control the control device 100 and the control device 200 respectively to enter the second state in step S312 to bypass the proximity pilot signal SPP and allow the authentication process to be performed through the manual mode. Therefore, when the user completes the authentication process through the manual mode, the charging station EVSE may still charge the electric vehicle EVH. On the other hand, if the authentication success message is received from the control device 200, this indicates that the identification code DD from the electric vehicle EVH is a valid identification code. Therefore, the controller 110 controls the control device 100 to enter the second state to bypass the proximity pilot signal SPP in step S313 and proceeds with the charging process in step S314.

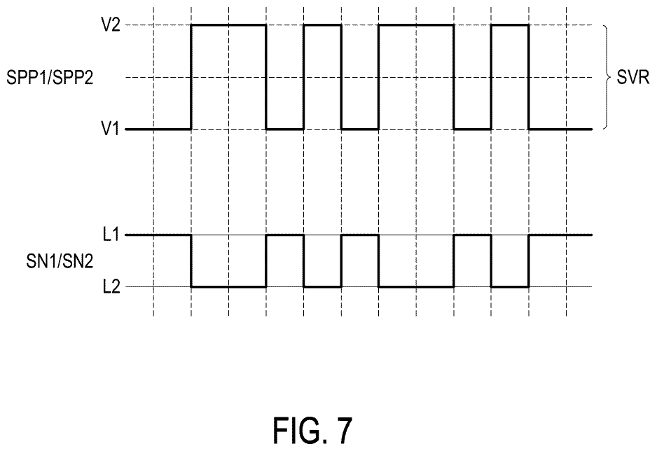

With reference to FIG. 3 and FIG. 7, FIG. 7 is a schematic diagram illustrating an operation of a signal processing circuit according to an embodiment of the disclosure. Taking the signal processing circuit 120 as an example, the signal processing circuit 120 may shift the voltage value of the first virtual proximity pilot signal SPP1 to generate the first communication data SN1. The signal processing circuit 120 may shift a logic level of the second communication data SN2 to generate the second virtual proximity pilot signal SPP2.

In an embodiment, the signal processing circuit 120 shifts a first voltage value V1 (e.g., 1.3 volts) of the first virtual proximity pilot signal SPP1 to a first logic level L1 and shifts a second voltage value V2 (e.g., 1.7 volts) of the first virtual proximity pilot signal SPP1 to a second logic level L2 to generate the first communication data SN1. In an embodiment, the first voltage value V1 and the second voltage value V2 are within a setting voltage value range SVR. For instance, the first voltage value V1 is a minimum voltage value of the setting voltage value range SVR, but the disclosure is not limited thereto. The second voltage value V2 is a maximum voltage value of the setting voltage value range SVR, but the disclosure is not limited thereto. The first logic level L1 is different from the second logic level L2. For instance, the first logic level L1 may be a high logic level (e.g., 3.3 volts), but the disclosure is not limited thereto. The second logic level L2 may be a low logic level (e.g., 0 volts), but the disclosure is not limited thereto.

Further, the signal processing circuit 120 shifts the first logic level L1 of the second communication data SN2 to the first voltage value V1 and shifts the second logic level L2 of the second communication data SN2 to the second voltage value V2 to generate the second virtual proximity pilot signal SPP2.

Taking the signal processing circuit 220 as an example, the signal processing circuit 220 may shift the logic level of the first communication data SN1 to generate the first virtual proximity pilot signal SPP1. The signal processing circuit 220 may shift the voltage value of the second virtual proximity pilot signal SPP2 to generate the second communication data SN2.

Further, the signal processing circuit 220 shifts the first logic level L1 of the first communication data SN1 to the first voltage value V1 and shifts the second logic level L2 of the first communication data SN1 to the second voltage value V2 to generate the first virtual proximity pilot signal SPP1. The signal processing circuit 220 shifts the first voltage value V1 of the second virtual proximity pilot signal SPP2 to the first logic level L1 and shifts the second voltage value V2 of the second virtual proximity pilot signal SPP2 to the second logic level L2 to generate the second communication data SN2.

In this embodiment, the voltage value of the first virtual proximity pilot signal SPP1 and the voltage value of the second virtual proximity pilot signal SPP2 are both within the setting parameter range (i.e., setting voltage value range). In some embodiments, the setting parameter range may be a setting current range, a setting frequency range, or a setting phase range. In other words, the current value, frequency, or phase of the first virtual proximity pilot signal SPP1 and the current value, frequency, or phase of the second virtual proximity pilot signal SPP2 are both within the setting parameter range.

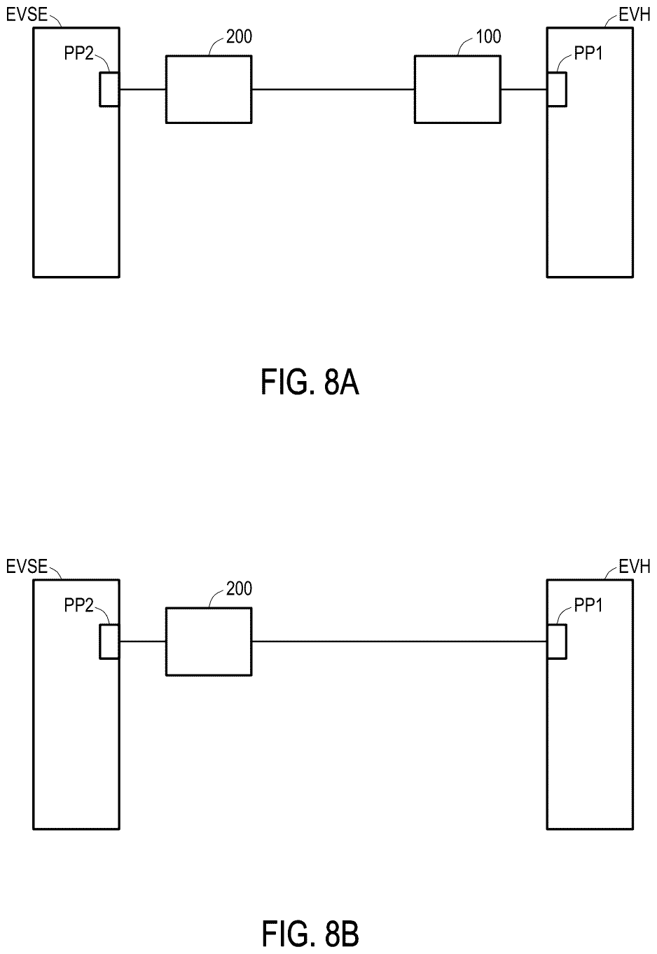

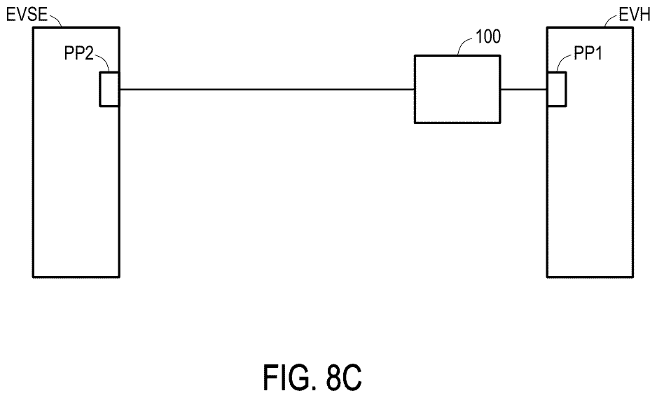

With reference to FIG. 3 and FIG. 8A, FIG. 8A is a schematic diagram illustrating a usage scenario according to an embodiment of the disclosure. In an embodiment, the control device 100 is arranged on the electric vehicle EVH. The control device 200 is arranged on the charging station EVSE. When the charging station EVSE is connected to the electric vehicle EVH, the control device 200 is connected to the control device 100 as well. Therefore, the control device 200 and the control device 100 transmit the proximity pilot signal SPP. When proximity detection is successful, the control device 200 enters the first state to automatically execute the authentication processes as shown in FIG. 5A and FIG. 5B (the authentication process of the control device and the authentication process of the electric vehicle EVH). The control device 100 enters the first state to automatically execute the authentication processes as shown in FIG. 6A to FIG. 6C (the authentication process of the control device and the authentication process of the electric vehicle EVH). During the authentication process, the first virtual proximity pilot signal SPP1 and the second virtual proximity pilot signal SPP2 within the setting parameter range replace the bypassed proximity pilot signal SPP. Therefore, the authentication process may not result in an erroneous judgment of proximity detection failure.

In response to completing the authentication operation, the control device 100 and the control device 200 enter the second state to bypass the proximity pilot signal SPP, and the charging station EVSE performs the charging process on the electric vehicle EVH.

In response to failing to complete the authentication operation, the control device 100 and the control device 200 enter the second state to bypass the proximity pilot signal SPP, and the charging station EVSE does not perform the charging process on the electric vehicle EVH.

With reference to FIG. 3 and FIG. 8B, FIG. 8B is a schematic diagram illustrating a usage scenario according to an embodiment of the disclosure. In an embodiment, the control device 200 is arranged on the charging station EVSE. The electric vehicle EVH is not equipped with the control device 100. When the charging station EVSE is connected to the electric vehicle EVH, the control device 200 transmits the proximity pilot signal SPP. When proximity detection is successful, the control device 200 enters the first state to automatically execute the control device authentication process. The control device 200 generates the first communication data SN1 and waits for the second communication data SN2. It should be noted that the electric vehicle EVH is not equipped with the control device 100. The control device 200 does not receive the second communication data SN2. Therefore, the control device authentication process cannot be completed. The control device 200 enters the second state to bypass the proximity pilot signal SPP, and the charging station EVSE may be allowed to perform the authentication process on the electric vehicle EVH through the manual mode.

With reference to FIG. 3 and FIG. 8C, FIG. 8C is a schematic diagram illustrating a usage scenario according to an embodiment of the disclosure. In an embodiment, the control device 100 is arranged on the electric vehicle EVH. The charging station EVSE is not equipped with the control device 200. When the charging station EVSE is connected to the electric vehicle EVH, the control device 100 transmits the proximity pilot signal SPP. When proximity detection is successful, the control device 100 enters the first state. It should be noted that the charging station EVSE is not equipped with the control device 200. The control device 100 does not receive the first communication data SN1. Therefore, the control device authentication process cannot be executed. The control device 100 enters the second state to bypass the proximity pilot signal SPP, and the charging station EVSE may be allowed to perform the authentication process on the electric vehicle EVH through the manual mode.

In view of the foregoing, in response to the proximity pilot signal being within the setting parameter range, the control device enters the first state to convert the first virtual proximity pilot signal into the first communication data. Therefore, the control device may utilize the first communication data to participate in the first authentication process. In this way, a way to simplify the authentication process is provided in the disclosure. Further, in an embodiment, the disclosure may be applied to the authentication process before charging the electric vehicle. After completing the first authentication process, the control device utilizes the identification code of the electric vehicle to participate in the second authentication process.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A control device for authentication, comprising:
a connection terminal configured to transmit a proximity pilot signal;
a transmission terminal configured to transmit a virtual proximity pilot signal, wherein the virtual proximity pilot signal is within a setting parameter range;
a first switch having a first end coupled to the connection terminal and a second end coupled to the transmission terminal;
a second switch having a first end coupled to the connection terminal;
a controller coupled to a control end of the first switch, a second end of the second switch, and a control end of the second switch and configured to turn on the second switch and turn off the first switch to enter a first state in response to the proximity pilot signal being within the setting parameter range; and
a signal processing circuit coupled to the controller and the transmission terminal and configured to receive a first virtual proximity pilot signal within the setting parameter range in the first state, convert the first virtual proximity pilot signal into first communication data for participating in a first authentication process, and provide the first communication data to the controller.

2. The control device according to claim 1, wherein
the setting parameter range is a setting voltage value range,
the signal processing circuit shifts a first voltage value of the first virtual proximity pilot signal to a first logic level and shifts a second voltage value of the first virtual proximity pilot signal to a second logic level to generate the first communication data,
the first logic level is different from the second logic level, and
the first voltage value and the second voltage value are within the setting voltage value range.

3. The control device according to claim 1, wherein the controller turns on the first switch and turns off the second switch to enter a second state in response to the proximity pilot signal being outside the setting parameter range.

4. The control device according to claim 1, wherein in the first state,
the controller provides second communication data for participating in the first authentication process, and
the signal processing circuit converts the second communication data into a second virtual proximity pilot signal within the setting parameter range and provides the second virtual proximity pilot signal to the transmission terminal.

5. The control device according to claim 4, wherein
the setting parameter range is a setting voltage value range,
the signal processing circuit shifts a first logic level of the second communication data to a first voltage value and shifts a second logic level of the second communication data to a second voltage value to generate the second virtual proximity pilot signal,
the first voltage value is different from the second voltage value, and
the first voltage value and the second voltage value are within the setting voltage value range.

6. The control device according to claim 4, wherein in the first state, the controller provides the second communication data based on the first communication data after receiving the first communication data.

7. The control device according to claim 1, wherein in the first state, the controller receives an identification code from an electric vehicle and uses the identification code for a second authentication process.

8. The control device according to claim 7, wherein in response to passing the second authentication process, the controller turns on the first switch and turns off the second switch to enter a second state.

9. An operating method for authentication, comprising:
providing a control device;
entering a first state by the control device in response to a proximity pilot signal being within a setting parameter range; and
receiving, by the control device, a first virtual proximity pilot signal within the setting parameter range in the first state and converting the first virtual proximity pilot signal into first communication data for participating in a first authentication process.

10. The operating method according to claim 9, wherein the setting parameter range is a setting voltage value range, wherein the step of converting the first virtual proximity pilot signal into the first communication data comprises:
shifting a first voltage value of the first virtual proximity pilot signal to a first logic level and shifting a second voltage value of the first virtual proximity pilot signal to a second logic level to generate the first communication data,
wherein the first logic level is different from the second logic level, and
wherein the first voltage value and the second voltage value are within the setting voltage value range.

11. The operation method according to claim 9, further comprising:
controlling the control device to enter a second state in response to the proximity pilot signal being outside the setting parameter range; and
bypassing the proximity pilot signal by the control device in the second state.

12. The operation method according to claim 9, further comprising:
providing, by the control device, second communication data for participating in the first authentication process, converting the second communication data into a second virtual proximity pilot signal within the setting parameter range, and transmitting the second virtual proximity pilot signal.

13. The operating method according to claim 12, wherein the setting parameter range is a setting voltage value range, wherein the operating method further comprises:
shifting, by the control device, a first logic level of the second communication data to a first voltage value and shifting a second logic level of the second communication data to a second voltage value to generate the second virtual proximity pilot signal,
wherein the first voltage value is different from the second voltage value, and
wherein the first voltage value and the second voltage value are within the setting voltage value range.

14. The operation method according to claim 9, further comprising:
providing another control device, wherein the control device is electrically connected to the another control device;
entering the first state by the another control device in response to another proximity pilot signal being within the setting parameter range,
wherein in the first state, the first virtual proximity pilot signal is provided by the another control device.

15. The operating method according to claim 14, wherein the setting parameter range is a setting voltage value range, wherein the operating method further comprises:
providing, by the another control device, the first communication data, shifting a first logic level of the first communication data to a first voltage value, shifting a second logic level of the first communication data to a second voltage value to generate the first virtual proximity pilot signal, and providing the first virtual proximity pilot signal to the control device in the first state,
wherein the first logic level is different from the second logic level, and
the first voltage value and the second voltage value are within the setting voltage value range.

16. The operating method according to claim 15, further comprising:
providing, by the control device, second communication data for participating in the first authentication process, converting the second communication data into a second virtual proximity pilot signal within the setting voltage value range, and outputting the second virtual proximity pilot signal to the another control device; shifting, by the another control device, a first voltage value of the second virtual proximity pilot signal to a first logic level, shifting a second voltage value of the second virtual proximity pilot signal to a second logic level to generate the second communication data, and identifying the control device based on the second communication data in the first state.

17. The operating method according to claim 16, further comprising:
in the first state, the control device receives an identification code from an electric vehicle and uses the identification code for a second authentication process.

18. The operating method according to claim 17, further comprising:
in response to passing the second authentication process, controlling the control device and the another control device to enter a second state to bypass the proximity pilot signal and the another proximity pilot signal.

19. A control device for authentication, comprising:
a connection terminal configured to transmit a proximity pilot signal;
a transmission terminal configured to transmit a virtual proximity pilot signal, wherein the virtual proximity pilot signal is within a setting parameter range;
a first switch having a first end coupled to the connection terminal and a second end coupled to the transmission terminal;
a second switch having a first end coupled to the connection terminal;
a controller coupled to a control end of the first switch, a second end of the second switch, and a control end of the second switch and configured to turn on the second switch and turn off the first switch to enter a first state in response to the proximity pilot signal being within the setting parameter range; and
a signal processing circuit coupled to the controller and the transmission terminal and configured to receive the virtual proximity pilot signal within the setting parameter range in the first state, convert the virtual proximity pilot signal into communication data for participating in a authentication process, and provide the communication data to the controller.

20. The control device according to claim 19, wherein
the setting parameter range is a setting voltage value range,
the signal processing circuit converts different voltage values of the virtual proximity pilot signal into corresponding logic levels to generate communication data, and
the different voltage values of the virtual proximity pilot signal are within the setting voltage value range, and the logic levels have different values.
